(19) United States
(12) Patent Application Publication
(10) Pub. No.: US 2009/0118410 A1
(43) Pub. Date: May 7, 2009

(54) Thermally Stable Aluminum Trihydroxide Particles Produced By Spray Drying With Subsequent Dry-Milling and Their Use

(75) Inventors: Rene Gabriel Erich Herbiet, Eupen (BE); Volker Ernst Willi Keller, Frechen (DE); Dagmar Linek, Cologne (DE); Winfried Toedt, Steffeln-Auel (DE); Norbert Wilhelm Puetz, Niederaussem (DE); Ingo Uwe Heim, Frechen (DE)

Correspondence Address: ALBEMARLE CORPORATION;PATENT DEPARTMENT, 451 FLORIDA STREET, BATON ROUGE, LA, 70801, US

(73) Assignee: Martinswerk GmbH, Bergheim (DE)

(21) Appl. No.: 12/300,423

(22) PCT Filed: Jun. 21, 2007
(86) PCT No.: PCT/IB2007/002314

§ 371 Date: Nov. 11, 2008

Related U.S. Application Data
(60) Provisional application No. 60/815,426, filed on Jun. 21, 2006.
(60) Provisional application No. 60/815,515, filed on Jun. 21, 2006.
(60) Provisional application No. 60/818,632, filed on Jul. 5, 2006.
(60) Provisional application No. 60/818,633, filed on Jul. 5, 2006.
(60) Provisional application No. 60/818,670, filed on Jul. 5, 2006.
(60) Provisional application No. 60/828,877, filed on Oct. 10, 2006.
(60) Provisional application No. 60/828,901, filed on Oct. 10, 2006.
(60) Provisional application No. 60/828,908, filed on Oct. 10, 2006.
(60) Provisional application No. 60/828,912, filed on Oct. 10, 2006.
(60) Provisional application No. 60/889,316, filed on Feb. 12, 2007.
(60) Provisional application No. 60/889,319, filed on Feb. 12, 2007.
(60) Provisional application No. 60/889,320, filed on Feb. 12, 2007.
(60) Provisional application No. 60/889,325, filed on Feb. 12, 2007.
(60) Provisional application No. 60/889,327, filed on Feb. 12, 2007.
(60) Provisional application No. 60/889,330, filed on Feb. 12, 2007.
(60) Provisional application No. 60/891,745, filed on Feb. 27, 2007.
(60) Provisional application No. 60/891,746, filed on Feb. 27, 2007.
(60) Provisional application No. 60/891,747, filed on Feb. 27, 2007.
(60) Provisional application No. 60/891,748, filed on Feb. 27, 2007.
(60) Provisional application No. 60/916,477, filed on May 7, 2007.

(51) Int. Cl. C08K 3/22; C01F 7/02

(52) U.S. Cl. 524/437; 423/629

(57) ABSTRACT

The present invention relates to a novel process for the production of aluminum hydroxide flame retardants having improved thermal stability, the aluminum hydroxide particles produced therefrom, the use of the aluminum hydroxide particles produced therefrom in flame retarded polymer formulations, and molded or extruded articles made from the flame retarded polymer formulations.

### FIELD OF THE INVENTION

The present invention relates to the production of mineral flame retardants. More particularly the present invention relates to a novel process for the production of aluminum hydroxide flame retardants having improved thermal stability.

### BACKGROUND OF THE INVENTION

Aluminum hydroxide has a variety of alternative names such as aluminum hydrate, aluminum trihydrate etc., but is commonly referred to as ATH. ATH particles, finds many uses as a filler in many materials such as, for example, papers, resins, rubber, plastics etc. These products find use in diverse commercial applications such as cable and wire sheaths, conveyor belts, thermoplastics moldings, adhesives, etc. ATH is typically used to improve the flame retardancy of such materials and also acts as a smoke suppressant. ATH also commonly finds use as a flame retardant in resins used to fabricate printed wiring circuit boards. Thus, the thermal stability of the ATH is a quality closely monitored by end users. For example, in printed circuit board applications, the thermal stability of the laminates used in constructing the boards must be sufficiently high to allow lead free soldering.

Methods for the synthesis and production of ATH are well known in the art. However, the demand for tailor made ATH grades is increasing, and the current processes are not capable of producing all of these grades. Thus, as the demand for tailor made ATH grades increases, the demand for processes to produce these grades is also increasing.

### SUMMARY OF THE INVENTION

While empirical evidence indicates that the thermal stability of an ATH is linked to the total soda content of the ATH, the inventors hereof have discovered and believe, while not wishing to be bound by theory, that the improved thermal stability of the ATH of the present invention is linked to the non-soluble soda content, which is typically in the range of from about 70 to about 99 wt. %, based on the weight of the total soda, of the total soda content, with the remainder being soluble soda.

The inventors hereof also believe, while not wishing to be bound by theory, that the wettability of ATH particles with resins depends on the morphology of the ATH particles, and the inventors hereof have unexpectedly discovered that by using the process of the present invention, ATH particles having an improved wettability in relation to ATH particles currently available can be produced. While not wishing to be bound by theory, the inventors hereof believe that this improved wettability is attributable to an improvement in the morphology of the ATH particles produced by the process disclosed herein.

The inventors hereof further believe, while not wishing to be bound by theory, that this improved morphology is attributable to the total specific pore volume and/or the median pore radius of the ATH product particles. The inventors hereof believe that, for a given polymer molecule, an ATH product having a higher structured aggregate contains more and bigger pores and seems to be more difficult to wet, leading to difficulties (higher variations of the power draw on the motor) during compounding in kneaders like Buss Ko-kneaders or twin-screw extruders or other machines known in the art and used to this purpose. Therefore, the inventors hereof have discovered that an ATH filler characterized by smaller median pore sizes and/or lower total pore volumes correlates with an improved wetting with polymeric materials and thus results in improved compounding behavior, i.e. less variations of the power draw of the engines (motors) of compounding machines used to compound a flame retarded resin containing the ATH filler. The inventors hereof have discovered that the process of the present invention is especially well-suited for producing an ATH having these characteristics.

Thus, in one embodiment, the present invention produces dry-milled ATH particles having a Vₘₐₓ, i.e. maximum specific pore volume at about 1000 bar, in the range of from about 300 to about 700 mm³/g and/or an r₅₀, i.e. a pore radius at 50% of the relative specific pore volume, in the range of from about 0.09 to about 0.33 μm, and one or more, preferably two or more, and more preferably three or more, in some embodiments all, of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

In another embodiment, the present invention relates to a flame retarded resin formulation comprising the dry-milled ATH particles produced by the process of the present invention.

In some embodiments, the dry-milled ATH particles of the present invention are further characterized as having a soluble soda content of less than about 0.1 wt. %.

The present invention also relates to a process for producing dry-milled ATH. The process generally comprises spray drying an aluminum hydroxide slurry or filter cake to produce spray-dried aluminum hydroxide particles, and dry-milling said spray-dried aluminum hydroxide particles thus producing dry-milled ATH particles as described herein.

### DETAILED DESCRIPTION OF THE INVENTION

It should be noted that all particle diameter measurements, i.e. d₅₀ values, disclosed herein were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

### Slurry and Filter Cake

In one embodiment of the present invention a slurry or a filter cake containing ATH particles is spray dried to produce spray dried ATH particles which are then dry milled, thus producing dry milled ATH particles. In one preferred embodiment, a slurry is spray-dried and in another preferred embodiment, a filter cake is spray-dried.

The slurry or the filter cake typically contains in the range of from about 1 to about 85 wt. % ATH particles, based on the total weight of the slurry or the filter cake. In some embodiments, the slurry or the filter cake contains in the range of from about 25 to about 85 wt. % ATH particles, in other embodiments in the range of from about 40 to about 70 wt. % ATH particles, sometimes in the range of from about 55 to about 65 wt. % ATH particles, all on the same basis. In other embodiments, the slurry or the filter cake contains in the range of from about 40 to about 60 wt. % ATH particles, sometimes in the range of from about 45 to about 55 wt. % ATH particles, both on the same basis. In still other embodiments, the slurry or the filter cake contains in the range of from about 25 to about 50 wt. % ATH particles, sometimes in the range of from about 30 to about 45 wt. % ATH particles, both on the same basis.

The slurry or the filter cake used in the practice of the present invention can be obtained from any process used to produce ATH particles. In some embodiments, the slurry or the filter cake is obtained from a process that involves producing ATH particles through precipitation and filtration. In an exemplary embodiment, the slurry or the filter cake is obtained from a process that comprises dissolving crude aluminum hydroxide in caustic soda to form a sodium aluminate liquor, which is cooled and filtered thus forming a sodium aluminate liquor useful in this exemplary embodiment. The sodium aluminate liquor thus produced typically has a molar ratio of Na₂O to Al₂O₃ in the range of from about 1.4:1 to about 1.55:1. In order to precipitate ATH particles from the sodium aluminate liquor, ATH seed particles are added to the sodium aluminate liquor in an amount in the range of from about 1 g of ATH seed particles per liter of sodium aluminate liquor to about 3 g of ATH seed particles per liter of sodium aluminate liquor thus forming a process mixture. The ATH seed particles are added to the sodium aluminate liquor when the sodium aluminate liquor is at a liquor temperature of from about 45 to about 80° C. After the addition of the ATH seed particles, the process mixture is stirred for about 100 h or alternatively until the molar ratio of Na₂O to Al₂O₃ is in the range of from about 2.2:1 to about 3.5:1, thus forming an ATH suspension. The obtained ATH suspension typically comprises from about 80 to about 160 g/l ATH, based on the suspension. However, the ATH concentration can be varied to fall within the ranges described above. The obtained ATH suspension is then filtered and washed to remove impurities therefrom, thus forming a filter cake. The filter cake can be washed one, or in some embodiments more than one, times with water, preferably de-salted water. This filter cake can then be directly spray dried.

However, in some embodiments, the filter cake can be re-slurried with water to form a slurry, or in a preferred embodiment, at least one, preferably only one, dispersing agent is added to the filter cake to form a slurry having an ATH concentration in the above-described ranges. It should be noted that it is also within the scope of the present invention to re-slurry the filter cake with a combination of water and a dispersing agent. Non-limiting examples of dispersing agents suitable for use herein include polyacrylates, organic acids, naphtalensulfonate/formaldehyde condensate, fatty-alcohol-polyglycol-ether, polypropylene-ethylenoxid, polyglycol-ester, polyamine- ethylenoxid, phosphate, polyvinylalcohole. If the slurry comprises a dispersing agent, the slurry may contain up to about 80 wt. % ATH, based on the total weight of the slurry, because of the effects of the dispersing agent. In this embodiment, the remainder of the slurry or the filter cake (i.e. not including the ATH particles and the dispersing agent(s)) is typically water, although some reagents, contaminants, etc. may be present from precipitation.

The inventors hereof, while not wishing to be bound by theory, believe that the improved morphology of the ATH particles produced by the present invention is at least partially attributable to the process used to precipitate the ATH. Thus, while dry milling techniques are known in the art, the inventors hereof have discovered that by using the precipitation and filtration processes described herein, including preferred embodiments, along with the dry milling process described herein, ATH particles having improved morphology, as described below, can be readily produced.

ATH Particles in the Slurry and/or Filter Cake

In some embodiments, the BET of the ATH particles in the filter cake and/or slurry is in the range of from about 1.0 to about 4.0 m²/g. In these embodiments, it is preferred that the ATH particles in the filter cake and/or slurry have a BET in the range of from about 1.5 to about 2.5 m²/g. In these embodiments, the ATH particles in the filter cake and/or slurry can also be, and preferably are, characterized by a d₅₀ in the range of from about 1.8 to about 3.5 μm, preferably in the range of from about 1.8 to about 2.5 μm, which is coarser than the dry-milled ATH particles produced herein.

In other embodiments, the BET of the ATH particles in the filter cake and/or slurry is in the range of from about 4.0 to about 8.0 m²/g, preferably in the range of from about 5 to about 7 m²/g. In these embodiments, the ATH particles in the filter cake and/or slurry can also be, and preferably are, characterized by a d₅₀ in the range of from about 1.5 to about 2.5 μm, preferably in the range of from about 1.6 to about 2.0 μm, which is coarser than the dry-milled ATH particles produced herein.

In still other embodiments, the BET of the ATH particles in the filter cake and/or slurry is in the range of from about 8.0 to about 14 m²/g, preferably in the range of from about 9 to about 12 m²/g. In these embodiments, the ATH particles in the filter cake and/or slurry can also be, and preferably are, characterized by a d₅₀ in the range of from about 1.5 to about 2.0 μm, preferably in the range of from about 1.5 to about 1.8 μm, which is coarser than the dry-milled ATH particles produced herein.

By coarser than the mill-dried ATH particles, it is meant that the upper limit of the d₅₀ value of the ATH particles in the filter cake and/or slurry is generally at least about 0.2 μm higher than the upper limit of the d₅₀ of the dry-milled ATH particles produced herein.

The ATH particles in the slurry and/or filter cake used in the present invention can also be characterized, and preferably are characterized by, a total soda content of less than about 0.2 wt. %, based on the ATH particles in the slurry or filter cake. In preferred embodiments, if the soluble soda content is a characteristic of the ATH particles, the total soda content is less than 0.18 wt. %, more preferably less than 0.12 wt. %, based on the total weight of the ATH particles in the slurry and/or filter cake. The total soda content of the ATH can be measured by using a flame photometer M7DC from Dr. Bruno Lange GmbH, Düsseldorf/Germany. In the present invention, the total soda content of the ATH particles was measured by first adding 1 g of ATH particles into a quartz glass bowl, then adding 3 ml of concentrated sulfuric acid to the quartz glass bowl, and carefully agitating the contents of the glass bowl with a glass rod. The mixture is then observed, and if the ATH-crystals do not completely dissolve, another 3 ml of concentrated sulfuric acid is added and the contents mixed again. The bowl is then heated on a heating plate until the excess sulfuric acid is completely evaporated. The contents of the quartz glass bowl are then cooled to about room temperature, and about 50 ml of deionized water is added to dissolve any salts in the bowl. The contents of the bowl are then maintained at increased temperature for about 20 minutes until the salts are dissolved. The contents of the glass bowl are then cooled to about 20° C., transferred into a 500 ml measuring flask, which is then filled up with deionized water and homogenized by shaking. The solution in the 500 ml measuring flask is then analyzed with the flame photometer for total soda content of the ATH particles.

The ATH particles in the slurry and/or filter cake used in the present invention can also be characterized, and preferably are characterized by, a soluble soda content of less than about 0.1 wt. %, based on the ATH particles in the slurry and/or filter cake. In other embodiments, the ATH particles in the filter cake and/or slurry can be further characterized as having a soluble soda content in the range of from greater than about 0.001 to about 0.1 wt. %, in some embodiments in the range of from about 0.02 to about 0.1 wt. %, both based on the ATH particles in the filter cake and/or slurry. While in other embodiments, the ATH particles in the filter cake and/or slurry can be further characterized as having a soluble soda content in the range of from about 0.001 to less than 0.04 wt %, in some embodiments in the range of from about 0.001 to less than 0.03 wt %, in other embodiments in the range of from about 0.001 to less than 0.02 wt %, on the same basis. The soluble soda content is measured via flame photometry. To measure the soluble soda content, a solution of the sample was prepared as follows: 20 g of the sample are transferred into a 1000 ml measuring flask and leached out with about 250 ml of deionized water for about 45 minutes on a water bath at approx. 95° C. The flask is then cooled to 20° C., filled to the calibration mark with deionized water, and homogenized by shaking. After settling of the sample, a clear solution forms in the flask neck, and, with the help of a filtration syringe or by using a centrifuge, as much of the solution as needed for the measurement in the flame photometer can be removed from the flask.

The ATH particles in the slurry and/or filter cake used in the practice of the present invention can also be described as having a non-soluble soda content, as described herein, in the range of from about 70 to about 99.8% of the total soda content, with the remainder being soluble soda. While empirical evidence indicates that the thermal stability is linked to the total soda content of the ATH, the inventors hereof, while not wishing to be bound by theory, believe that the improved thermal stability of the dry-milled ATH particles produced by the process of the present invention is linked to the non-soluble soda content, which is typically in the range of from about 70 to about 99.8 wt. % of the total soda content, with the remainder being soluble soda. In some embodiments of the present invention, the total soda content of the ATH particles in the slurry and/or filter cake used in the practice of the present invention is typically in the range of less than about 0.20 wt. %, based on the ATH particles in the slurry and/or filter cake, preferably in the range of less than about 0.18 wt. %, based on the ATH particles in the slurry and/or filter cake, more preferably in the range of less than about 0.12 wt. %, on the same basis. In other embodiments of the present invention, the total soda content of the ATH particles in the slurry and/or filter cake used in the practice of the present invention is typically in the range of less than about 0.30 wt. %, based on the ATH particles in the slurry and/or filter cake, preferably in the range of less than about 0.25 wt. %, based on the ATH particles in the slurry and/or filter cake, more preferably in the range of less than about 0.20 wt. %, on the same basis. In still other embodiments of the present invention, the total soda content of the ATH particles in the slurry and/or filter cake used in the practice of the present invention is typically in the range of less than about 0.40 wt. %, based on the ATH particles in the slurry and/or filter cake, preferably in the range of less than about 0.30 wt. %, based on the ATH particles in the slurry and/or filter cake, more preferably in the range of less than about 0.25 wt. %, on the same basis.

### Spray-Drying

Spray drying is a technique that is commonly used in the production of aluminum hydroxide. This technique generally involves the atomization of an ATH feed, here the milled ATH slurry or the filter cake, through the use of nozzles and/or rotary atomizers. The atomized feed is then contacted with a hot gas, typically air, and the spray dried ATH is then recovered from the hot gas stream. The contacting of the atomized feed can be conducted in either a counter or co-current fashion, and the gas temperature, atomization, contacting, and flow rates of the gas and/or atomized feed can be controlled to produce ATH particles having desired product properties.

The recovery of the spray dried ATH can be achieved through the use of recovery techniques such as filtration or just allowing the spray-dried particles to fall to collect in the spray drier where they can be removed, but any suitable recovery technique can be used. In preferred embodiments, the spray dried ATH is recovered from the spray drier by allowing it to settle, and screw conveyors recover it from the spray-drier and subsequently convey through pipes into a silo by means of compressed air.

The spray-drying conditions are conventional and are readily selected by one having ordinary skill in the art with knowledge of the desired ATH particle product qualities, described below Generally, these conditions include inlet air temperatures between typically 250 and 550° C. and outlet air temperatures typically between 105 and 150° C.

The spray-dried ATH is then subjected to dry-milling.

### Dry-Milling

By dry-milling, it is meant that the spray-dried ATH is subjected to a further treatment wherein the ATH is de-agglomerated with little reduction in the particle size of the spray-dried ATH. By “little particle size reduction” it is meant that the d₅₀ of the dry-milled ATH is in the range of from about 40% to about 90% of the ATH in the slurry or the filter cake prior to spray drying. In preferred embodiments, the d₅₀ of the dry-milled ATH is in the range of from about 60% to about 80% of the ATH in the slurry or the filter cake prior to spray drying, more preferably within the range of from about 70% to about 75% of the ATH in the slurry or the filter cake prior to spray drying.

The mill used in dry-milling the spray dried ATH can be selected from any dry-mills known in the art. Non-limiting examples of suitable dry mills include ball or media mills, cone and gyratory crushers, disk attrition mills, colloid and roll mills, screen mills and granulators, hammer and cage mills, pin and universal mills, impact mills and breakers, jaw crushers, jet and fluid energy mills, roll crushers, disc mills, and vertical rollers and dry pans, vibratory mills.

The dry-milled ATH recovered from the dry-milling of the spray-dried ATH can be classified via any classification techniques known because during dry milling, agglomerates can be produced, depending on the mill used. Non-limiting examples of suitable classification techniques include air classification. It should be noted that some mills have a built-in air classifier; if this is not the case, a separate air classifier can be used. If a pin mill is not used in the dry-milling, the dry-milled ATH can be subjected to further treatment in one or more pin mills.

The dry-milling of the spray-dried ATH is conducted under conditions effective at producing a dry-milled ATH particles having the properties discussed herein.

### Dry-Milled ATH Particles According to the Present Invention

In general, the dry-milling of the spray-dried ATH particles produces dry-milled ATH particles that are generally characterized as having a specific total specific pore volume and/or median pore radius (“r₅₀”) in addition to one or more, preferably two or more, and more preferably three or more, in some embodiments all, of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

As stated above, the inventors hereof believe that, for a given polymer molecule, ATH particles having a higher structured aggregate contain more and bigger pores and seems to be more difficult to wet, leading to difficulties (higher variations of the power draw on the motor) during compounding in kneaders like Buss Ko-kneaders or twin-screw extruders or other machines known in the art and used to this purpose. The inventors hereof have discovered that the dry-milled ATH particles of the present invention are characterized by smaller median pore sizes and/or lower total pore volumes, which correlates with an improved wetting with polymeric materials and thus results in improved compounding behavior, i.e. less variations of the power draw of the engines (motors) of compounding machines used to compound a flame retarded resin containing the ATH filler.

The r₅₀ and the specific pore volume at about 1000 bar (“Vₘₐₓ”) of the spray-dried ATH particles can be derived from mercury porosimetry. The theory of mercury porosimetry is based on the physical principle that a non-reactive, non-wetting liquid will not penetrate pores until sufficient pressure is applied to force its entrance. Thus, the higher the pressure necessary for the liquid to enter the pores, the smaller the pore size. A smaller pore size and/or a lower total specific pore volume were found to correlate to better wettability of the dry-milled ATH particles. The pore size of the dry-milled ATH particles can be calculated from data derived from mercury porosimetry using a Porosimeter 2000 from Carlo Erba Strumentazione, Italy. According to the manual of the Porosimeter 2000, the following equation is used to calculate the pore radius r from the measured pressure p: r=−2 γ cos(θ)/p; wherein θ is the wetting angle and γ is the surface tension. The measurements taken herein used a value of 141.3° for θ and γ was set to 480 dyn/cm.

In order to improve the repeatability of the measurements, the pore size of the dry-milled ATH particles was calculated from the second ATH intrusion test run, as described in the manual of the Porosimeter 2000. The second test run was used because the inventors observed that an amount of mercury having the volume V₀ remains in the sample of the dry-milled ATH particles after extrusion, i.e. after release of the pressure to ambient pressure. Thus, the r₅₀ can be derived from this data as explained below.

In the first test run, a sample of dry-milled ATH particles was prepared as described in the manual of the Porosimeter 2000, and the pore volume was measured as a function of the applied intrusion pressure p using a maximum pressure of 1000 bar. The pressure was released and allowed to reach ambient pressure upon completion of the first test run. A second intrusion test run (according to the manual of the Porosimeter 2000) utilizing the same dry-milled ATH sample, unadulterated, from the first test run was performed, where the measurement of the specific pore volume V(p) of the second test run takes the volume V₀ as a new starting volume, which is then set to zero for the second test run.

In the second intrusion test run, the measurement of the specific pore volume V(p) of the sample was again performed as a function of the applied intrusion pressure using a maximum pressure of 1000 bar. The pore volume at about 1000 bar, i.e. the maximum pressure used in the measurement, is referred to as Vₘₐₓ herein.

From the second dry-milled ATH intrusion test run, the pore radius r was calculated by the Porosimeter 2000 according to the formula r=−2 γ cos(θ)/p; wherein θ is the wetting angle, γ is the surface tension and p the intrusion pressure. For all r-measurements taken herein, a value of 141.3° for θ was used and γ was set to 480 dyn/cm. If desired, the specific pore volume can be plotted against the pore radius r for a graphical depiction of the results generated. The pore radius at 50% of the relative specific pore volume, by definition, is called median pore radius r₅₀ herein.

For a graphical representation of r₅₀ and Vₘₐₓ, please see U.S. Provisional Patent Applications 60/818,632; 60/818,633; 60/818,670; 60/815,515; and 60/818,426, which are all incorporated herein in their entirety.

The procedure described above was repeated using samples of dry-milled ATH particles according to the present invention, and the dry-milled ATH particles were found to have an r₅₀, i.e. a pore radius at 50% of the relative specific pore volume, in the range of from about 0.09 to about 0.33 μm. In some embodiments of the present invention, the r₅₀ of the dry-milled ATH particles is in the range of from about 0.20 to about 0.33 μm, preferably in the range of from about 0.2 to about 0.3 μm. In other embodiments, the r₅₀ is in the range of from about 0.185 to about 0.325 μm, preferably in the range of from about 0.185 to about 0.25 μm. In still other preferred embodiments, the r₅₀ is in the range of from about 0.09 to about 0.21 μm, more preferably in the range of from about 0.09 to about 0.165 μm.

The dry-milled ATH particles can also be characterized as having a Vₘₐₓ, i.e. maximum specific pore volume at about 1000 bar, in the range of from about 300 to about 700 mm³/g. In some embodiments of the present invention, the Vₘₐₓ of the dry-milled ATH particles is in the range of from about 390 to about 480 mm³/g, preferably in the range of from about 410 to about 450 mm³/g. In other embodiments, the Vₘₐₓ is in the range of from about 400 to about 600 mm³/g, preferably in the range of from about 450 to about 550 mm³/g. In yet other embodiments, the Vₘₐₓ is in the range of from about 300 to about 700 mm³/g, preferably in the range of from about 350 to about 550 mm³/g.

The dry-milled ATH particles can also be characterized as having an oil absorption, as determined by ISO 787-5:1980, of less than bout 50%, sometimes in the range of from about 1 to about 50%. In some embodiments, the dry-milled ATH particles are characterized as having an oil absorption in the range of from about 23 to about 30%, preferably in the range of from about 24% to about 29%, more preferably in the range of from about 25% to about 28%. In other embodiments, the dry-milled ATH particles are characterized as having an oil absorption in the range of from about 25% to about 40%, preferably in the range of from about 25% to about 35%, more preferably in the range of from about 26% to about 30%. In still other embodiments, the dry-milled ATH particles are characterized as having an oil absorption in the range of from about 25 to about 50%, preferably in the range of from about 26% to about 40%, more preferably in the range of from about 27% to about 32%. In other embodiments, the oil absorption of the dry-milled ATH particles is in the range of from about 19% to about 23%, and in still other embodiments, the oil absorption of the dry-milled ATH particles produced is in the range of from about 21% to about 25%.

The dry-milled ATH particles can also be characterized as having a BET specific surface area, as determined by DIN-66132, in the range of from about 1 to 15 m²/g. In some embodiments, the dry-milled ATH particles have a BET specific surface in the range of from about 3 to about 6 m²/g, preferably in the range of from about 3.5 to about 5.5 m²/g. In other embodiments, the dry-milled ATH particles have a BET specific surface of in the range of from about 6 to about 9 m²/g, preferably in the range of from about 6.5 to about 8.5 m²/g. In still other embodiments, the dry-milled ATH particles have a BET specific surface in the range of from about 9 to about 15 m²/g, preferably in the range of from about 10.5 to about 12.5 m²/g,

The dry-milled ATH particles can also be characterized as having a d₅₀ in the range of from about 0.5 to 2.5 μm. In some embodiments, the dry-milled ATH particles produced by the present invention have a d₅₀ in the range of from about 1.5 to about 2.5 μm, preferably in the range of from about 1.8 to about 2.2 μm. In other embodiments, the dry-milled ATH particles have a d₅₀ in the range of from about 1.3 to about 2.0 μm, preferably in the range of from about 1.4 to about 1.8 μm. In still other embodiments, the dry-milled ATH particles have a d₅₀ in the range of from about 0.9 to about 1.8 μm, more preferably in the range of from about 1.1 to about 1.5 μm.

The dry-milled ATH particles can also be characterized as having a total soda content of less than about 0.4 wt. %, based on the dry-milled ATH particles. In some embodiments, if the soluble soda content is a characteristic of the dry-milled ATH particles, the total soda content is less than about 0.20 wt. %, preferably less than about 0.18 wt. %, more preferably less than 0.12 wt. %, all based on the total weight of the dry-milled ATH particles. In other embodiments, if the soluble soda content is a characteristic of the dry-milled ATH particles, the total soda content is less than about 0.30, preferably less than about 0.25 wt. %, more preferably less than 0.20 wt. %, based on the total weight of the dry-milled ATH particles. In other embodiments, if the soluble soda content is a characteristic of the dry-milled ATH particles, the total soda content is less than about 0.40, preferably less than about 0.30 wt. %, more preferably less than 0.25 wt. %, based on the total weight of the dry-milled ATH particles. The total soda content can be measured according to the procedure outlined above.

The dry-milled ATH particles can also be characterized as having a thermal stability, as described in Tables 1, 2, and 3, below.

TABLE 1

| | 1 wt. % TGA (° C.) | 2 wt. % TGA (° C.) |
|---|---|---|
| Typical | 210-225 | 220-235 |
| Preferred | 210-220 | 220-230 |
| More Preferred | 214-218 | 224-228 |

TABLE 2

| | 1 wt. % TGA (° C.) | 2 wt. % TGA (° C.) |
|---|---|---|
| Typical | 200-215 | 210-225 |
| Preferred | 200-210 | 210-220 |
| More Preferred | 200-205 | 210-215 |

TABLE 3

| | 1 wt. % TGA (° C.) | 2 wt. % TGA (° C.) |
|---|---|---|
| Typical | 195-210 | 205-220 |
| Preferred | 195-205 | 205-215 |
| More Preferred | 195-200 | 205-210 |

Thermal stability, as used herein, refers to release of water of the dry-milled ATH particles and can be assessed directly by several thermoanalytical methods such as thermogravimetric analysis (“TGA”), and in the present invention, the thermal stability of the dry-milled ATH particles was measured via TGA. Prior to the measurement, the dry-milled ATH particle samples were dried in an oven for 4 hours at about 105° C. to remove surface moisture. The TGA measurement was then performed with a Mettler Toledo by using a 70 μl alumina crucible (initial weight of about 12 mg) under N₂ (70 ml per minute) with the following heating rate: 30° C. to 150° C. at 10° C. per min, 150° C. to 350° C. at 1° C. per min, 350° C. to 600° C. at 10° C. per min. The TGA temperature of the dry-milled ATH particles (pre-dried as described above) was measured at 1 wt. % loss and 2 wt. % loss, both based on the weight of the dry-milled ATH particles. It should be noted that the TGA measurements described above were taken using a lid to cover the crucible.

The dry-milled ATH particles can also be characterized as having an electrical conductivity in the range of less than about 200 μS/cm, in some embodiments less than 150 μS/cm, and in other embodiments, less than 100 μS/cm. In other embodiments, the electrical conductivity of the dry-milled ATH particles is in the range of about 10 to about 45 μS/cm. It should be noted that all electrical conductivity measurements were conducted on a solution comprising water and about at 10 wt. % dry-milled ATH, based on the solution, as described below.

The electrical conductivity was measured by the following procedure using a MultiLab 540 conductivity measuring instrument from Wissenschaftlich-Technische-Werkstätten GmbH, Weilheim/Germany: 10 g of the sample to be analyzed and 90 ml deionized water (of ambient temperature) are shaken in a 100 ml Erlenmeyer flask on a GFL 3015 shaking device available from Gesellschaft for Labortechnik mbH, Burgwedel/Germany for 10 minutes at maximum performance. Then the conductivity electrode is immersed in the suspension and the electrical conductivity is measured.

The dry-milled ATH particles can also be characterized as having a soluble soda content of less than about 0.1 wt. %, based on the dry-milled ATH particles. In other embodiments, the dry-milled ATH particles can be further characterized as having a soluble soda content in the range of from greater than about 0.001 to about 0.1 wt. %, in some embodiments in the range of from about 0.02 to about 0.1 wt. %, both based on the dry-milled ATH particles. While in other embodiments, the dry-milled ATH particles can be further characterized as having a soluble soda content in the range of from about 0.001 to less than 0.03 wt %, in some embodiments in the range of from about 0.001 to less than 0.04 wt %, in other embodiments in the range of from about 0.001 to less than 0.02 wt %, all on the same basis. The soluble soda content can be measured according to the procedure outlined above.

The dry-milled ATH particles can be, and preferably are, characterized by the non-soluble soda content. While empirical evidence indicates that the thermal stability of an ATH is linked to the total soda content of the ATH, the inventors hereof have discovered and believe, while not wishing to be bound by theory, that the improved thermal stability of the dry-milled ATH particles produced by the process of the present invention is linked to the non-soluble soda content. The non-soluble soda content of the dry-milled ATH particles of the present invention is typically in the range of from about 70 to about 99.8% of the total soda content of the dry-milled ATH, with the remainder being soluble soda. In some embodiments of the present invention, the total soda content of the dry-milled ATH particles is typically in the range of less than about 0.20 wt. %, based on the dry-milled ATH, preferably in the range of less than about 0.18 wt.%, based on the dry-milled ATH, more preferably in the range of less than about 0.12 wt. %, on the same basis. In other embodiments of the present invention, the total soda content of the dry-milled ATH particles is typically in the range of less than about 0.30 wt. %, based on the dry-milled ATH, preferably in the range of less than about 0.25 wt. %, based on the dry-milled ATH, more preferably in the range of less than about 0.20 wt. %, on the same basis. In still other embodiments of the present invention, the total soda content of the dry-milled ATH particles is typically in the range of less than about 0.40 wt. %, based on the dry-milled ATH, preferably in the range of less than about 0.30 wt. %, based on the dry-milled ATH, more preferably in the range of less than about 0.25 wt. %, on the same basis.

### Use of the Dry-Milled ATH

The dry-milled ATH particles according to the present invention can be used as a flame retardant in a variety of synthetic resins. Thus, in one embodiment, the present invention relates to a flame retarded polymer formulation comprising at least one synthetic resin, in some embodiments only one, and a flame retarding amount of dry-milled ATH particles according to the present invention, and molded and/or extruded articles made from the flame retarded polymer formulation.

By a flame retarding amount of the dry-milled ATH particles, it is generally meant in the range of from about 5 wt % to about 90 wt %, based on the weight of the flame retarded polymer formulation, preferably in the range of from about 20 wt % to about 70 wt %, on the same basis. In a most preferred embodiment, a flame retarding amount is in the range of from about 30 wt % to about 65 wt % of the dry-milled ATH particles, on the same basis. Thus, the flame retarded polymer formulation typically comprises in the range of from about 10 to about 95 wt. % of the at least one synthetic resin, based on the weight of the flame retarded polymer formulation, preferably in the range of from about 30 to about 40 wt. % of the flame retarded polymer formulation, more preferably in the range of from about 35 to about 70 wt. % of the at least one synthetic resin, all on the same basis.

Non-limiting examples of thermoplastic resins where the ATH particles find use include polyethylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, vinyl chloride-propylene copolymer, vinyl acetate resin, phenoxy resin, and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (latices).

Preferably, the synthetic resin is a polyethylene-based resins such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyvinyl chloride and rubbers. In a more preferred embodiment, the synthetic resin is a polyethylene-based resin.

The flame retarded polymer formulation can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; barium stearate or calcium sterate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation and the method by which the molding is conducted is not critical to the present invention and can be any known in the art so long as the method selected involves uniform mixing and molding. For example, each of the above components, and optional additives if used, can be mixed using a Buss Ko-kneader, internal mixers, Farrel continuous mixers or twin screw extruders or in some cases also single screw extruders or two roll mills, and then the flame retarded polymer formulation molded in a subsequent processing step. Further, the molded article of the flame-retardant polymer formulation may be used after fabrication for applications such as stretch processing, emboss processing, coating, printing, plating, perforation or cutting. The kneaded mixture can also be inflation-molded, injection-molded, extrusion-molded, blow-molded, press-molded, rotation-molded or calender-molded.

In the case of an extruded article, any extrusion technique known to be effective with the synthetic resin(s) used in the flame retarded polymer formulation can be employed. In one exemplary technique, the synthetic resin, dry-milled ATH particles, and optional components, if chosen, are compounded in a compounding machine to form the flame-retardant resin formulation. The flame-retardant resin formulation is then heated to a molten state in an extruder, and the molten flame-retardant resin formulation is then extruded through a selected die to form an extruded article or to coat for example a metal wire or a glass fiber used for data transmission.

In some embodiments, the synthetic resin is selected from epoxy resins, novolac resins, phosphorous containing resins like DOPO, brominated epoxy resins, unsaturated polyester resins and vinyl esters. In this embodiment, a flame retarding amount of dry-milled ATH particles is in the range of from about 5 to about 200 parts per hundred resins (“phr”) of the ATH. In preferred embodiments, the flame retarded formulation comprises from about 15 to about 100 phr preferably from about 15 to about 75 phr, more preferably from about 20 to about 55 phr, of the dry-milled ATH particles. In this embodiment, the flame retarded polymer formulation can also contain other additives commonly used in the art with these particular resins. Non-limiting examples of other additives that are suitable for use in this flame retarded polymer formulation include other flame retardants based e.g. on bromine, phosphorous or nitrogen; solvents, curing agents like hardeners or accelerators, dispersing agents or phosphorous compounds, fine silica, clay or talc. The proportions of the other optional additives are conventional and can be varied to suit the needs of any given situation. The preferred methods of incorporation and addition of the components of this flame retarded polymer formulation is by high shear mixing. For example, by using shearing a head mixer manufactured for example by the Silverson Company. Further processing of the resin-filler mix to the “prepreg” stage and then to the cured laminate is common state of the art and described in the literature, for example in the “Handbook of Epoxide Resins”, published by the McGraw-Hill Book Company, which is incorporated herein in its entirety by reference.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, when discussing the oil absorption of the dry-milled ATH, it is contemplated that ranges from about 30% to about 32%, about 19% to about 25%, about 21% to about 27%, etc. are within the scope of the present invention.

1-25. (canceled)

26. A process for producing dry-milled ATH particles comprising:
a) spray drying an aluminum hydroxide slurry or filter cake containing in the range of from about 1 to about 85 wt. % ATH, based on the total weight of the slurry and/or filter cake, to produce spray-dried aluminum hydroxide particles; and
b) dry milling said spray dried aluminum hydroxide particles thus producing dry-milled ATH particles, wherein the dry-milled ATH particles have a Vₘₐₓ in the range of from about 300 to about 700 mm³/g and/or an r₅₀ in the range of from about 0.09 to about 0.33 μm, and one or more of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

27. The process according to claim 26 wherein said slurry or filter cake is obtained from a process that involves producing ATH particles through precipitation and filtration.

28. The process according to claim 26 wherein said slurry or filter cake is obtained from a process that comprises:
a) dissolving aluminum hydroxide in caustic soda to form a sodium aluminate liquor; filtering the sodium aluminate solution to remove impurities; cooling and diluting the sodium aluminate liquor to an appropriate temperature and concentration; adding ATH seed particles to the sodium aluminate solution; allowing ATH particles to precipitate from the solution thus forming an ATH suspension containing in the range of from about 80 to about 160 g/l ATH, based on the suspension; filtering the ATH suspension thus forming said filter cake, and optionally washing said filter cake one or more times with water before it is spray dried; or,
b) dissolving aluminum hydroxide in caustic soda to form a sodium aluminate liquor; filtering the sodium aluminate solution to remove impurities; cooling and diluting the sodium aluminate liquor to an appropriate temperature and concentration; adding ATH seed particles to the sodium aluminate solution; allowing ATH particles to precipitate from the solution thus forming an ATH suspension containing in the range of from about 80 to about 160 g/l ATH, based on the suspension; filtering the ATH suspension thus forming a filter cake; optionally washing said filter cake one or more times with water before it is re-slurried; and re-slurrying said filter cake to form a slurry comprising in the range of from about 1 to about 85 wt. % ATH, based on the total weight of the slurry.

29. The process according to claim 26 wherein the BET of the ATH particles in the slurry or filter cake is a) in the range of from about 1.0 to about 4.0 m²/g or b) in the range of from about 4.0 to about 8.0 m²/g, or c) in the range of from about 8.0 to about 14 m²/g; and/or wherein the ATH particles in the slurry or filter cake have a d₅₀ in the range of from about 1.5 to about 3.5 μm.

30. The process according to claim 29 wherein said slurry or filter cake contains i) in the range of from about 1 to about 85 wt. % ATH particles; ii) in the range of from about 25 to about 70 wt. % ATH particles; iii) in the range of from about 55 to about 65 wt. % ATH particles; in the range of from about 40 to about 60 wt. % ATH particles; iv) in the range of from about 45 to about 55 wt. % ATH particles; v) in the range of from about 25 to about 50 wt. % ATH particles; or vi) in the range of from about 30 to about 45 wt. % ATH particles; wherein all wt. % are based on the total weight of the slurry or the filter cake.

31. The process according to any of claims 26 or 29 wherein the ATH particles in the slurry or filter cake have: a) a total soda content of: i) less than about 0.2 wt. %, based on the ATH particles in the slurry or filter cake; or ii) less than about 0.1 wt. %, based on the ATH particles in the slurry or filter cake; and/or b) a non-soluble soda content in the range of from about 70 to about 99.8% of the total soda content, with the remainder being soluble soda.

32. The process according to claim 26 wherein said slurry or filter cake comprises a dispersing agent.

33. The process according to claim 26 wherein said dry-milled ATH particles are classified or treated in one or more pin mills.

34. The dry-milled ATH particles according to claim 26.

35. Dry-milled ATH particles having a Vₘₐₓ in the range of from about 300 to about 700 mm³/g and/or an r₅₀ in the range of from about 0.09 to about 0.33 μm, and one or more of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

36. The dry-milled ATH particles according to claim 35 wherein said dry-milled ATH particles have an oil absorption in the range of from about 19 to about 23%.

37. The dry-milled ATH particles according to claim 35 wherein the dry-milled ATH particles have:
a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, a Vₘₐₓ in the range of from about 390 to about 480 mm³/g, a total soda content of less than about 0.2 wt. %, an electrical conductivity in the range of less than about 100 μS/cm, a soluble soda content in the range of from 0.001 to less than 0.02 wt %, based on the dry-milled ATH particles, a non-soluble soda content in the range of from about 70 to about 99.8% of the total soda content of the dry-milled ATH and a thermal stability, determined by thermogravimetric analysis, as described in Table 1:
TABLE 1

| 1 wt. % TGA (° C.) | 2 wt. % TGA (° C.) |
|---|---|
| 210-225 | 220-235 |

or
b) a BET in the range of from about 6 to about 9 m²/g, a d₅₀ in the range of from about 1.3 to about 2.0 μm, an oil absorption in the range of from about 25 to about 40%, an r₅₀ in the range of from about 0.185 to about 0.325 μm, a Vₘₐₓ in the range of from about 400 to about 600 mm³/g, a total soda content of less than about 0.3 wt. %, an electrical conductivity in the range of less than about 150 μS/cm, a soluble soda content in the range of from 0.001 to less than 0.03 wt %, based on the dry-milled ATH particles, a non-soluble soda content in the range of from about 70 to about 99.8% of the total soda content of the dry-milled ATH and a thermal stability, determined by thermogravimetric analysis, as described in Table 2:
TABLE 2

| 1 wt. % TGA (° C.) | 2 wt. % TGA (° C.) |
|---|---|
| 200-215 | 210-225 |

or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, a Vₘₐₓ in the range of from about 300 to about 700 mm³/g, a total soda content of less than about 0.4 wt. %, an electrical conductivity in the range of less than about 200 μS/cm, a soluble soda content in the range of from 0.001 to less than 0.04 wt %, based on the dry-milled ATH particles, a non-soluble soda content in the range of from about 70 to about 99.8% of the total soda content of the dry-milled ATH and a thermal stability, determined by thermogravimetric analysis, as described in Table 3:
TABLE 3

| 1 WT. % TGA (° C.) | 2 WT. % TGA (° C.) |
|---|---|
| 195-210 | 205-220 |

38. The dry-milled particles according to claim 35 wherein said dry-milled ATH particles have a non-soluble soda content in the range of from about 70 to about 99 wt. % of the total soda content of the dry-milled ATH.

39. A flame retarded polymer formulation comprising at least one synthetic resin and in the range of from about 5 wt % to about 90 wt %, based on the weight of the flame retarded polymer formulation of the dry-milled ATH particles according to claim 35.

40. The flame retarded polymer formulation according to claim 39 wherein said dry-milled ATH particles having a Vₘₐₓ in the range of from about 300 to about 700 mm³/g and/or an r₅₀ in the range of from about 0.09 to about 0.33 μm, and one or more of the following characteristics:
i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

41. The flame retarded polymer formulation according to claim 40 wherein said dry-milled ATH particles have an oil absorption in the range of from about 19 to about 23%.

42. The flame retarded polymer formulation according to claim 40 wherein the dry-milled ATH particles have:
a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, a Vₘₐₓ in the range of from about 390 to about 480 mm³/g, a total soda content of less than about 0.2 wt. %, an electrical conductivity in the range of less than about 100 μS/μm, a soluble soda content in the range of from 0.001 to less than 0.02 wt %, based on the dry-milled ATH particles, a non-soluble soda content in the range of from about 70 to about 99.8% of the total soda content of the dry-milled ATH and a thermal stability, determined by thermogravimetric analysis, as described in Table 1:
TABLE 1

| 1 wt. % TGA (° C.) | 2 wt. % TGA (° C.) |
|---|---|
| 210-225 | 220-235 |

or
b) a BET in the range of from about 6 to about 9 m²/g, a d₅₀ in the range of from about 1.3 to about 2.0 μm, an oil absorption in the range of from about 25 to about 40%, an r₅₀ in the range of from about 0.185 to about 0.325 μm, a Vₘₐₓ in the range of from about 400 to about 600 mm³/g, a total soda content of less than about 0.3 wt. %, an electrical conductivity in the range of less than about 150 μS/cm, a soluble soda content in the range of from 0.001 to less than 0.03 wt %, based on the dry-milled ATH particles, a non-soluble soda content in the range of from about 70 to about 99.8% of the total soda content of the dry-milled ATH and a thermal stability, determined by thermogravimetric analysis, as described in Table 2:
TABLE 2

| 1 wt. % TGA (° C.) | 2 wt. % TGA (° C.) |
|---|---|
| 200-215 | 210-225 |

or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, a Vₘₐₓ in the range of from about 300 to about 700 mm³/g, a total soda content of less than about 0.4 wt. %, an electrical conductivity in the range of less than about 200 μS/cm, a soluble soda content in the range of from 0.001 to less than 0.04 wt %, based on the dry-milled ATH particles, a non-soluble soda content in the range of from about 70 to about 99.8% of the total soda content of the dry-milled ATH and a thermal stability, determined by thermogravimetric analysis, as described in Table 3:
TABLE 3

| 1 WT. % TGA (° C.) | 2 WT. % TGA (° C.) |
|---|---|
| 195-210 | 205-220 |

43. The flame retarded polymer formulation according to claim 42 wherein said dry-milled ATH particles have a non-soluble soda content in the range of from about 70 to about 99 wt. % of the total soda content of the dry-milled ATH.

44. A molded or extruded article made from the flame retarded polymer formulation according to any of claims 39-43.
